(19) United States
(12) Patent Application Publication
(10) Pub. No.: US 2024/0258506 A1
(43) Pub. Date: Aug. 1, 2024

(54) POSITIVE ELECTRODE LAYER

(71) Applicants: TOYOTA JIDOSHA KABUSHIKI KAISHA, Toyota-shi (JP); PRIME PLANET ENERGY & SOLUTIONS, INC., Tokyo (JP)

(72) Inventors: Momoko PROCTER, Seto-shi (JP); Chika NOGUCHI, Toyota-shi (JP); Shimpei KONDO, Nagoya-shi (JP)

(73) Assignees: TOYOTA JIDOSHA KABUSHIKI KAISHA, Toyota-shi (JP); PRIME PLANET ENERGY & SOLUTIONS, INC., Tokyo (JP)

(21) Appl. No.: 18/505,549

(22) Filed: Nov. 9, 2023

(30) Foreign Application Priority Data
Jan. 26, 2023 (JP) 2023-010420

(51) Int. Cl. H01M 4/36; H01M 4/131; H01M 4/48; H01M 4/505; H01M 4/525; H01M 4/62

(52) U.S. Cl. CPC H01M 4/366; H01M 4/131; H01M 4/48; H01M 4/505; H01M 4/525; H01M 4/625

(57) ABSTRACT

In the present disclosure, the above problem can be addressed by providing a positive electrode layer used in a lithium ion secondary battery, wherein the positive electrode layer contains a positive electrode active material and carbon nanotubes, wherein the positive electrode active material contains tungsten and is secondary particles including a plurality of primary particles and voids formed between the plurality of primary particles, wherein the positive electrode layer contains, as the carbon nanotubes, first carbon nanotubes of which at least some are included in the voids of the secondary particles, and wherein spectrums at rising positions (10,195 eV to 10,206 eV) of peaks of L absorption edges of tungsten measured by X-ray absorption fine structure analysis (XAFS) satisfy:

$$( a - b ) / ( c - b ) \leq 0.79 . \qquad Formula ( 1 )$$

### CROSS-REFERENCE TO RELATED APPLICATION

This application claims priority to Japanese Patent Application No. 2023-010420 filed on Jan. 26, 2023, incorporated herein by reference in its entirety.

### BACKGROUND

### 1. Technical Field

The present disclosure relates to a positive electrode layer used in a lithium ion secondary battery.

### 2. Description of Related Art

Lithium ion secondary batteries are put into practical use not only as small power sources for mobile phones and laptops but also as medium- and large-sized power sources for automobiles and power storage.

Research focusing on positive electrode active materials is focusing on improving performance of lithium ion secondary batteries. For example, in Japanese Unexamined Patent Application Publication No. 2021-018895 (JP 2021-018895 A), an object is to provide a non-aqueous electrolyte secondary battery which has a low initial resistance and in which an increase in resistance when charging and discharging are repeated is reduced, and a non-aqueous electrolyte secondary battery including a positive electrode containing porous particles having a coating containing tungsten oxide (WO₃, hexavalent tungsten) and lithium tungstate on the surface as a positive electrode active material, which are lithium composite oxide porous particles having a specific porosity and two or more specific voids, is disclosed. Here, the valence of tungsten in lithium tungstate is not specified in JP 2021-018895 A.

In addition, Japanese Unexamined Patent Application Publication No. 2020-184490 (JP 2020-184490 A) discloses that a part of the surface of the positive electrode active material is covered with carbon nanotubes as a conductive material.

### SUMMARY

In order to improve performance of lithium ion secondary batteries, it is preferable that cycle characteristics be favorable. The present disclosure has been made in view of the above circumstances, and a main object of the present disclosure is to provide a positive electrode layer that can improve cycle characteristics of lithium ion secondary batteries.

[1] A positive electrode layer used in a lithium ion secondary battery, wherein the positive electrode layer contains a positive electrode active material and carbon nanotubes, wherein the positive electrode active material contains tungsten and is secondary particles including a plurality of primary particles and voids formed between the plurality of primary particles, wherein the positive electrode layer contains, as the carbon nanotubes, first carbon nanotubes of which at least some are included in the voids of the secondary particles, and wherein spectrums at rising positions (10,195 eV to 10,206 eV) of peaks of L absorption edges of tungsten measured by X-ray absorption fine structure analysis (XAFS) satisfy: Formula (1): (a-b)/(c-b)<0.79 [in Formula (1), a represents an energy (eV) when the slope of the spectrum is the largest in the range of 10,195 eV to 10,206 eV, and when a spectral intensity at a (eV) is set as A, b represents an energy (eV) at which the spectral intensity becomes A in a range of 10,195 eV to 10,206 eV of WO₂ (tungsten(IV) oxide), and c represents an energy (eV) at which the spectral intensity becomes A in a range of 10,195 eV to 10,206 eV of WO₃ (tungsten(VI) oxide)].

[2] The positive electrode layer according to [1], wherein the positive electrode layer contains, as the carbon nanotubes, second carbon nanotubes that are not included in the voids of the secondary particles.

[3] The positive electrode layer according to [1] or [2], wherein Formula (1) satisfies 0.22≤(a−b)/(c−b)≤0.79.

[4] The positive electrode layer according to any one of [1] to [3], wherein the positive electrode active material contains a lithium metal composite oxide.

The present disclosure has an effect of improving cycle characteristics of lithium ion secondary batteries.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic cross-sectional diagram illustrating a positive electrode active material in the present disclosure;

FIG. 1B is a schematic cross-sectional diagram illustrating the positive electrode active material in the present disclosure;

FIG. 2 is a diagram for illustrating Formula (1) in the present disclosure; and

FIG. 3 is a diagram for illustrating Formula (1) in the present disclosure.

### DETAILED DESCRIPTION OF EMBODIMENTS

Hereinafter, a positive electrode layer in the present disclosure will be described in detail. Here, in this specification, “to” indicating a numerical range means that numerical values stated before and after “to” are included as a lower limit value and an upper limit value.

### 1. Positive Electrode Layer

The positive electrode layer in the present disclosure is a positive electrode layer used in a lithium ion secondary battery, and contains a positive electrode active material and carbon nanotubes. In addition, the positive electrode active material contains tungsten and is secondary particles including a plurality of primary particles and voids formed between the plurality of primary particles. In addition, the positive electrode layer contains, as the carbon nanotubes, first carbon nanotubes of which at least some are included in the voids of the secondary particles. In addition, the positive electrode layer in the present disclosure satisfies Formula (1): (a−b)/(c−b)≤0.79 when measured through X-ray absorption fine structure analysis (XAFS). Here, in this specification, “voids formed between primary particles” may be referred to as “voids of secondary particles.” In addition, “voids of secondary particles” generally indicates the inner space of secondary particles surrounded by a plurality of primary particles.

According to the present disclosure, since the positive electrode layer contains first carbon nanotubes of which at least some are included in the voids of the secondary particles, cycle characteristics can be improved when used in a lithium ion secondary battery.

When the battery is repeatedly charged and discharged, the positive electrode active material may expand and contract and cracks may occur. In particular, when charging and discharging are performed under high load conditions, there is a concern that the positive electrode active material is likely to crack. If cracks occur, there is a risk of the contact between the positive electrode active material and the conductive material such as carbon nanotubes being broken and a favorable electron conduction path not being maintained. As a result, there is a risk of the battery resistance increasing. On the other hand, it is thought that, since the positive electrode layer in the present disclosure contains first carbon nanotubes of which at least some are included in the voids of the secondary particles in the positive electrode active material, even if cracks occur in the positive electrode active material, fragments of the cracked positive electrode active material can come in contact with the first carbon nanotubes, and the electron conduction path can be maintained. As a result, it is thought that deterioration in cycle characteristics of the lithium ion secondary battery can be reduced.

In addition, in the positive electrode layer in the present disclosure, when measured through X-ray absorption fine structure analysis (XAFS), since a predetermined Formula (1) is satisfied, the battery resistance can be reduced. Although details will be described below, it is thought that, when tungsten in the positive electrode layer is tetravalent or has an average valence between tetravalent and hexavalent, the tungsten exhibits high conductivity and an effect of lowering active energy. As a result, it is thought that, when the positive electrode layer in the present disclosure is used in a lithium ion battery, it is possible to reduce the battery resistance.

### (1) Positive Electrode Active Material

The positive electrode active material in the present disclosure contains tungsten.

Tungsten may be present inside the primary particles in the positive electrode active material. That is, tungsten may be present as one component constituting the composition of the primary particles. In addition, tungsten may be present on the surfaces of the primary particles. That is, tungsten (a tungsten compound) may be present so that it covers the surfaces of the primary particles (for example, the primary particles of the lithium metal composite oxide to be described below). In this case, tungsten may be present between the primary particles. In addition, tungsten may be present on the surfaces of the secondary particles in the positive electrode active material. That is, tungsten (a tungsten compound) may be present so that it covers the surfaces of the secondary particles (for example, the secondary particles of the lithium metal composite oxide to be described below). For example, after the secondary particles are produced, the surfaces of the secondary particles may be covered with tungsten (a tungsten compound). In this case, tungsten is generally not present at the contact interface between adjacent primary particles constituting the secondary particles.

Tungsten contained in the positive electrode active material may be tetravalent tungsten or a mixture of tetravalent tungsten and hexavalent tungsten in a range in which spectrums including rising positions (10,195 eV to 10,206 eV) of peaks of L absorption edges of tungsten satisfy Formula (1) to be described below.

Examples of tetravalent tungsten compounds include lithium tungstate containing WO₂ and tetravalent tungsten and lithium nickel cobalt manganese composite oxides containing tetravalent tungsten.

Examples of hexavalent tungsten compounds include lithium tungstate containing hexavalent tungsten such as WO₃ and Li₂WO₄ and lithium nickel cobalt manganese composite oxides containing hexavalent tungsten.

The content of tungsten (the content of tungsten in the entire positive electrode active material) is not particularly limited, and may be, for example, 0.1 mass % or more, 0.3 mass % or more, or 0.5 mass % or more. On the other hand, the content of tungsten is, for example, 1.0 mass % or less, and may be 0.8 mass % or less or 0.6 mass % or less. If the content of tungsten is within the above range, it is possible to further reduce the battery resistance of the lithium ion secondary battery. The content of tungsten can be determined by elemental analysis through ICP (high frequency inductively coupled plasma) emission spectroscopy.

The positive electrode active material may further contain a lithium metal composite oxide as an essential component or may contain a lithium metal composite oxide having a layered structure.

Examples of lithium metal composite oxides include lithium nickel composite oxides, lithium manganese composite oxides, lithium cobalt composite oxides, lithium nickel cobalt aluminum composite oxides, lithium iron nickel manganese composite oxides, and lithium nickel cobalt manganese composite oxides. Among these, lithium nickel cobalt manganese composite oxides may be used because they have better resistance characteristics.

Here, in this specification, “lithium nickel cobalt manganese composite oxide” includes an oxide containing Li, Ni, Co, Mn, and O as constituent elements, and an oxide containing one, two or more additive elements other than these. Examples of such additive elements include transition metal elements such as Mg, Ca, Al, Ti, V, Cr, Si, Y, Zr, Nb, Mo, Hf, Ta, W, Na, Fe, Zn, and Sn, and typical metal elements. In addition, the additive elements may be semi-metal elements such as B, C, Si, and P and non-metal elements such as S, F, Cl, Br, and I. The content of these additive elements is preferably 0.1 mol or less with respect to lithium. The same applies to the above lithium nickel composite oxides, lithium cobalt composite oxides, lithium manganese composite oxides, lithium nickel cobalt aluminum composite oxides, lithium iron nickel manganese composite oxides and the like.

In addition, the positive electrode active material in the present disclosure is secondary particles including a plurality of primary particles and voids formed between the plurality of primary particles.

The primary particles preferably contain tungsten described above. In addition, the primary particles more preferably contain the above tungsten and lithium metal composite oxide.

The primary particles may have voids. In other words, the primary particles may be porous particles. The voids are the same as the voids in the secondary particles to be described below.

The average particle size (D₅₀) of primary particles is, for example, 0.01 μm or more and 100 μm or less. Here, the average particle size (D₅₀) is a particle size of cumulative 50% in a volume-based particle size distribution measured by a laser diffraction type particle size distribution measurement device.

The secondary particles may be particles composed of only the above primary particles containing tungsten or may be particles containing the above primary particles containing tungsten and other primary particles (for example, particles containing no tungsten and containing a lithium metal composite oxide).

In addition, the secondary particles have voids. The ratio (porosity) of voids is not particularly limited, and is, for example, 20% or more and 50% or less. The porosity can be determined, for example, by observing the cross section of the positive electrode active material with a scanning electron microscope (SEM). In addition, the porosity can be determined by pore size distribution measurement using a mercury porosimeter.

In addition, the voids may have a predetermined average pore size (radius), and the average pore size is, for example, 1 nm or more and 500 nm or less. The average pore size can be determined by, for example, mercury porosimeter measurement.

The average particle size (D₅₀) of the secondary particles is, for example, 0.1 μm or more and 1,000 μm or less. The average particle size is the same as above.

The proportion of the positive electrode active material in the positive electrode layer is not particularly limited, and is, for example, 50 mass % or more and 90 mass % or less.

The method of producing the positive electrode active material in the present disclosure is not particularly limited as long as the above positive electrode active material can be obtained, and for example, methods described in examples to be described may be exemplified.

### (2) Carbon Nanotube (CNT)

The positive electrode layer in the present disclosure contains carbon nanotubes. Carbon nanotubes function as a conductive material.

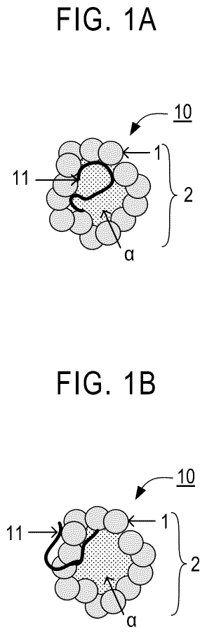

The positive electrode layer contains, as the carbon nanotubes, first carbon nanotubes of which at least some are included in the voids of the secondary particles. Here, the positions of carbon nanotubes present will be described with reference to FIG. 1A and FIG. 1B. FIG. 1A and FIG. 1B are schematic cross-sectional diagrams illustrating the positive electrode active material in the present disclosure. As shown in FIG. 1A, in a positive electrode active material 10, all first carbon nanotubes 11 may be included in voids a of (inside) secondary particles 2 formed by aggregation of primary particles 1. On the other hand, as shown in FIG. 1B, some of the first carbon nanotubes 11 may be present in voids a of (inside) the secondary particles 2 and some thereof may be present outside (on the outer surfaces of) the secondary particles.

As a method for incorporating first carbon nanotubes into the voids of the secondary particles, for example, methods described in examples to be described may be exemplified.

In addition, the positive electrode layer may contain, as the carbon nanotubes, second carbon nanotubes that are not included in the voids of the secondary particles.

The second carbon nanotubes can be contained in the positive electrode layer by adding carbon nanotubes when a positive electrode mixture to be described below is produced.

The ratio of the first carbon nanotubes and the second carbon nanotubes in the positive electrode layer is not particularly limited. When the mass of the first carbon nanotubes is X1 and the mass of the second carbon nanotubes is X2, X1/X2 is, for example, 0.1 or more and 3 or less.

The proportion of the carbon nanotubes in the positive electrode layer is not particularly limited and is, for example, 0.5 mass % or more and 20 mass % or less.

### (3) Positive Electrode Layer

In the positive electrode layer in the present disclosure, spectrums at rising positions (10,195 eV to 10,206 eV) of peaks of L absorption edges of tungsten measured by X-ray absorption fine structure analysis (XAFS) satisfy:

$$( a - b ) / ( c - b ) \leq 0.79 \qquad Formula ( 1 )$$

[in Formula (1), a represents an energy (eV) when the slope of the spectrum is the largest in the range of 10,195 eV to 10,206 eV, and
when a spectral intensity at a (eV) is set as A,
b represents an energy (eV) at which the spectral intensity becomes A in a range of 10,195 eV to 10,206 eV of WO₂ (tungsten(IV) oxide), and
c represents an energy (eV) at which the spectral intensity becomes A in a range of 10,195 eV to 10,206 eV of WO₃ (tungsten(VI) oxide)].

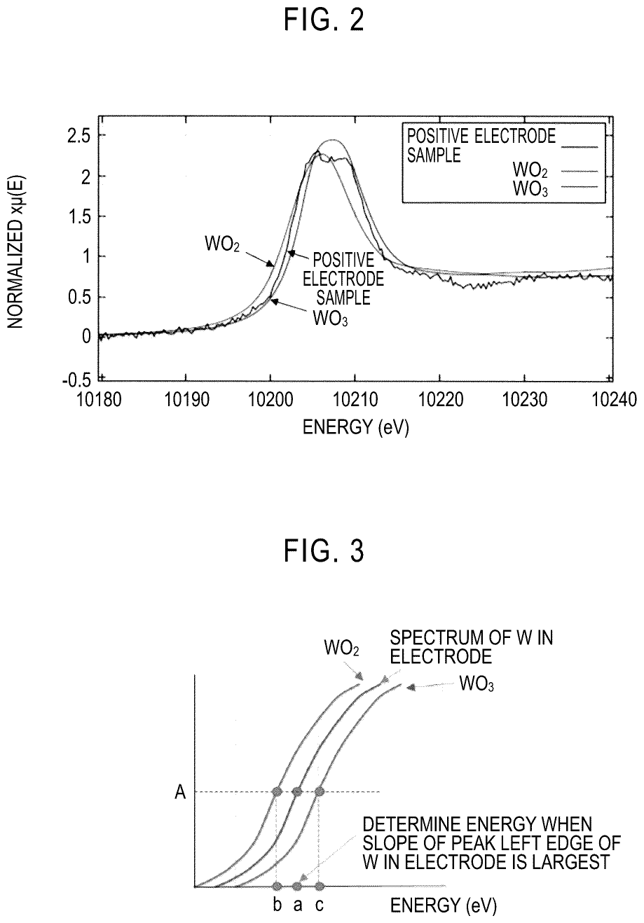

Here, Formula (1) will be described with reference to FIG. 2 and FIG. 3. FIG. 2 is a diagram showing XAFS measurement spectrums of the positive electrode layer in the present disclosure (positive electrode sample), WO₂ and WO₃. Specifically, FIG. 2 shows spectrums including rising positions (10,195 eV to 10,206 eV) of peaks of L absorption edges of tungsten according to XAFS measurement of a positive electrode sample, WO₂ (tungsten(IV) oxide) and WO₃ (tungsten(VI) oxide). In addition, FIG. 3 is a partially enlarged diagram showing rising positions of peaks of L absorption edges of tungsten according to XAFS measurement spectrums of a positive electrode sample, WO₂ and WO₃.

The rising position of the peak of the L absorption edge of tungsten in the XAFS measurement spectrum represents the valence of elemental tungsten. In the present disclosure, at the rising position (10,195 eV to 10,206 eV) of the peak of the L absorption edge of tungsten in the XAFS measurement spectrum of the positive electrode sample, the energy (eV) when the slope of the spectrum is the largest is set as a, and is used as an index of the peak rising position. Spectrums in the range of 10,195 eV to 10,206 eV are differentiated and a can be identified as the peak top energy of the differentiation. When the spectral intensity at a (eV) is set as A, b represents the energy (eV) at which the spectral intensity becomes A in the range of 10,195 eV to 10,206 eV of WO₂ (tungsten(IV) oxide), and c represents the energy (eV) at which the spectral intensity becomes A in the range of 10,195 eV to 10,206 eV of WO₃ (tungsten(VI) oxide). Here, WO₂ is used as a standard sample of tetravalent tungsten, and WO₃ is used as a standard sample of hexavalent tungsten.

In Formula (1), when (a−b)/(c−b)=1, it is interpreted that tungsten in the positive electrode layer (in the positive electrode active material) is hexavalent. In addition, in Formula (1), when (a−b)/(c−b)=0, it is interpreted that tungsten in the positive electrode layer is tetravalent. In addition, in Formula (1), when (a−b)/(c−b)≤0.79 is satisfied, it is interpreted that tungsten in the positive electrode layer is tetravalent or has an average valence between tetravalent and hexavalent.

Tungsten having an average valence between tetravalent and hexavalent is considered as a mixture of tetravalent tungsten and hexavalent tungsten, and has a lower average valence than hexavalent tungsten, high conductivity, and an effect of lowering active energy. Therefore, it is thought that, when tungsten in the positive electrode layer is tetravalent or has an average valence between tetravalent and hexavalent, the tungsten exhibits high conductivity and an effect of lowering active energy, and thus cell resistance can be reduced. In addition, it is thought that tungsten having a low valence easily dissolves in Ni, Co, Mn and the like used for the positive electrode active material, and when it dissolves, the crystal axis of the crystal structure of the positive electrode active material expands and thus the diffusion resistance of lithium ions can be reduced. For the reasons described above, it is thought that, when the positive electrode layer in the present disclosure is used in a lithium ion battery, the battery resistance can be reduced.

(a−b)/(c−b) in Formula (1) may be 0.70 or less, 0.60 or less, or 0.50 or less. On the other hand, (a−b)/(c−b) in Formula (1) may be, for example, 0.20 or more, 0.30 or more or 0.40 or more. Here, the XAFS measurement for obtaining (a−b)/(c−b) in Formula (1) will be described in examples to be described below.

The positive electrode layer in the present disclosure may contain at least one of an electrolyte and a binder in addition to the positive electrode active material and carbon nanotubes described above. In addition, the positive electrode layer may contain a conductive material other than the carbon nanotubes.

The electrolyte may be a liquid electrolyte or a solid electrolyte. Examples of liquid electrolytes include electrolytes containing an organic solvent such as ethylene carbonate (EC), dimethyl carbonate (DMC) and ethyl methyl carbonate (EMC), and a supporting salt such as LiPF₆. Examples of solid electrolytes include inorganic solid electrolytes such as an oxide solid electrolyte and a sulfide solid electrolyte. In addition, examples of binders include a rubber binder and a fluoride binder. Examples of conductive materials other than carbon nanotubes include particulate carbon materials such as acetylene black (AB) and ketjen black (KB), and fibrous carbon materials such as carbon nanofibers (CNF).

The thickness of the positive electrode layer is not particularly limited, and is, for example, 0.1 μm or more and 1,000 μm or less.

The method of producing a positive electrode layer is not particularly limited, and examples thereof include a method of applying a positive electrode mixture containing at least the above positive electrode active material (a positive electrode active material in which the first carbon nanotubes are included in voids of secondary particles) and a solvent to a substrate such as a positive electrode current collector and performing drying. At least one of carbon nanotubes (second carbon tubes), a binder, a conductive material and an electrolyte can be added to the positive electrode mixture.

### 2. Lithium Ion Secondary Battery

The positive electrode layer in the present disclosure is used in a lithium ion secondary battery. Therefore, in the present disclosure, it is possible to provide a solid lithium ion secondary battery having a positive electrode layer, a negative electrode layer and a solid electrolyte layer disposed between the positive electrode layer and the negative electrode layer, in which the positive electrode layer is the above positive electrode layer. In addition, the lithium ion secondary battery generally includes a positive electrode current collector that collects a current of the positive electrode layer and a negative electrode current collector that collects a current of the negative electrode layer. The lithium ion secondary battery may be a liquid battery containing a liquid electrolyte as an electrolyte or a solid battery containing a solid electrolyte as an electrolyte.

The positive electrode layer is as described in “1. Positive electrode layer.” As the negative electrode layer, the electrolyte layer, the positive electrode current collector and the negative electrode current collector, conventionally known members used for lithium ion secondary batteries can be used.

Applications of lithium ion secondary batteries include power sources for vehicles, for example, hybrid electric vehicles (HEV), plug-in hybrid electric vehicles (PHEV), battery electric vehicles (BEV), gasoline vehicles, and diesel vehicles. In particular, the battery is preferably used as power sources for driving hybrid electric vehicles (HEV), plug-in hybrid electric vehicles (PHEV) or battery electric vehicles (BEV). In addition, the battery may be used as a power source for moving objects (for example, trains, ships, aircrafts) other than vehicles and may be used as a power source for electrical products such as image processing devices.

Here, the present disclosure is not limited to the above embodiments. The above embodiments are examples, and any embodiment that has substantially the same configuration and exhibits the same operation and effect as in the technical idea described in the scope of claims in the present disclosure may be used and are included in the technical scope of the present disclosure.

### Example 1

### (Preparation of Positive Electrode Active Material)

A raw material aqueous solution containing nickel sulfate, cobalt sulfate, and manganese sulfate at a molar ratio of 1:1:1 was prepared. On the other hand, in a reaction container, a reaction solution whose pH was adjusted using sulfuric acid and ammonia water was prepared. In addition, an aqueous sodium hydroxide solution was prepared as a pH adjusting solution. Next, the raw material aqueous solution was added to the reaction solution at a predetermined rate with stirring, and the mixture was neutralized with a pH adjusting solution. After the crystallized product was washed with water, filtration and drying were performed to obtain composite hydroxide particles (precursor particles).

The obtained precursor particles and lithium carbonate were mixed. Here, a molar ratio (Li/Me) of lithium (Li) to a total amount of nickel, cobalt and manganese (Me) was set to 1.1. This mixture was fired in an electric furnace at 870° C. for 15 hours. After cooling to room temperature in the furnace, a pulverization treatment was performed to obtain a lithium metal composite oxide (LiNi_{1/3}Co_{1/3}Mn_{1/3}O₂) as spherical fired powder particles (secondary particles) in which primary particles were aggregated. Here, when the obtained lithium composite oxide was observed under a microscope, it was confirmed that a sufficient amount of gaps (voids of secondary particles) were present between primary particles.

The obtained lithium metal composite oxide, tungsten(IV) oxide (WO₂), and tungsten(VI) oxide (WO₃) were mixed at a ratio at which the ratio of tungsten (W/(lithium metal composite oxide+WO₂+WO₃)) was 0.5 mass %. The mixture was treated in a mechanochemical device at 3,000 rpm for 30 minutes, and additionally heated at 150° C. for 1 hour to obtain a positive electrode active material as a lithium metal composite oxide having a tungsten oxide (WO₂, WO₃) coating.

The obtained positive electrode active material was analyzed through transmission electron microscope-energy dispersive X-ray analysis (TEM-EDX). As a result, it was clearly understood that tungsten was incorporated into the primary particles of the lithium metal composite oxide.

### (Production of Positive Electrode Layer)

The obtained positive electrode active material, a conductive material (carbon nanotubes) and a binder (polyvinylidene fluoride) were weighed out at a ratio of positive electrode active material:conductive material:binder-88:10:2 (in terms of mass ratio). A dispersion medium was added to the obtained mixture and the mixture was stirred to obtain a positive electrode slurry. The obtained positive electrode slurry was applied onto a positive electrode current collector (Al foil) using a film applicator (with a film thickness adjusting function, commercially available from Allgood Co., Ltd.) and then dried at 80° C. for 5 minutes. Thereby, a positive electrode structure having a positive electrode current collector and a positive electrode layer was obtained.

### (Production of Evaluation Battery (Lithium Ion Secondary Battery))

Natural graphite (C) as a negative electrode active material, styrene butadiene rubber (SBR) as a binder and carboxymethyl cellulose (CMC) as a thickener were mixed in deionized water at a mass ratio of C:SBR:CMC=98:1:1 to prepare a paste for forming a negative electrode active material layer. This paste was applied onto both surfaces of a negative electrode current collector (Cu foil) with a thickness of 10 μm and dried and then pressed to produce a negative electrode structure having a negative electrode layer on both surfaces of the negative electrode current collector.

In addition, as separator sheets, two porous polyolefin sheets having a 3-layer structure of PP/PE/PP and having a thickness of 24 μm were prepared. The produced positive electrode structure and negative electrode structure and the two prepared separator sheets were superimposed and wound to produce a wound electrode body. Electrode terminals were attached by welding to a positive electrode and a negative electrode of the produced wound electrode body and this was accommodated in a battery case having a liquid injection port.

Subsequently, a non-aqueous electrolytic solution was injected from the liquid injection port of the battery case and the liquid injection port was airtightly sealed. Here, for the non-aqueous electrolytic solution, a solution in which LiPF₆ as a supporting salt was dissolved at a concentration of 1.0 mol/L in a mixed solvent containing ethylene carbonate (EC), dimethyl carbonate (DMC) and ethyl methyl carbonate (EMC) at a volume ratio of 3:4:3 was used. As described above, an evaluation battery (lithium ion secondary battery) was obtained.

### Example 2 to Example 4

Positive electrode active materials and evaluation batteries were produced in the same manner as in Example 1 except that, in production of the positive electrode active material, proportions of respective materials were adjusted so that the amount of tungsten (W/(lithium metal composite oxide+WO₂+WO₃) was the value shown in Table 1.

### Comparative Example 1

By changing conditions for preparing the lithium composite oxide, a lithium composite oxide with no or very few gaps between primary particles (voids of secondary particles) was prepared. In addition, only tungsten(VI) oxide (WO₃) was used as tungsten oxide. Except for these differences, a positive electrode active material and an evaluation battery were produced in the same manner as in Example 1.

### Comparative Example 2 and Comparative Example 4

By changing conditions for preparing the lithium composite oxide, a lithium composite oxide with no or very few gaps between primary particles (voids of secondary particles) was prepared. In addition, the ratio of WO₂ and WO₃ added was changed so that (a−b)/(c−b) in the positive electrode active material was the value in Table 1, and at least one of a heat treatment temperature (100° C. to 200° C.) and a heat treatment time (0.5 hours to 2.0 hours) was changed. Except for these differences, positive electrode active materials and evaluation batteries were produced in the same manner as in Example 1.

### Comparative Example 3

A positive electrode active material and an evaluation battery were produced in the same manner as in Example 1 except that the ratio of WO₂ and WO₃ added was changed so that (a−b)/(c−b) in the positive electrode active material was the value in Table 1, and at least one of a heat treatment temperature (100° C. to 200° C.) and a heat treatment time (0.5 hours to 2.0 hours) was changed.

### [Evaluation]

### (SEM Observation)

The positive electrode layers obtained in the examples and comparative examples were observed with a cross-sectional SEM to check the positions of carbon nanotubes present in the positive electrode active material. The results are shown in Table 1. Here, in Table 1, “only the surface” means that the first carbon nanotubes were not observed and only the second carbon nanotubes were observed. The reason why the first carbon nanotubes were not observed in Comparative Examples 1, 2 and 4 was speculated to be that, in the produced lithium composite oxide, there were not sufficient voids for the carbon nanotubes to enter the interior of the positive electrode active material (secondary particles).

### (Measurement of Content of Tungsten in Positive Electrode Active Material)

1 g of the obtained positive electrode active material was weighed out, and heated in a mixed solution containing 5 ml of nitric acid and 10 ml of a hydrogen peroxide solution, which are commercially available, using a heater at 300° C. until complete dissolution was visually confirmed. The residue was filtered, the volume was adjusted to 100 ml with pure water, and the content (mass %) of elemental tungsten was measured based on ICP emission spectroscopy. The results are shown in Table 1. Here, as the ICP optical emission spectrometer, an ICP optical emission spectrometer (commercially available from Hitachi High-Tech Science Corporation) was used.

### (X-Ray Absorption Fine Structure Analysis (XAFS) Measurement of Positive Electrode Layer)

For the positive electrodes obtained in the examples and comparative examples, XAFS measurement was performed using the following device. In addition, for tungsten(IV) oxide (WO₂) and tungsten(VI) oxide (WO₃) as standard samples, XAFS measurement was performed using the following device. The value of (a−b)/(c−b) in Formula (1) was obtained from spectrums at rising positions (10,195 eV to 10,206 eV) of peaks of L absorption edges of tungsten measured through XAFS. Table 1 shows the results of (a−b)/(c−b) in Example 1 to Example 4 and Comparative Example 1 to Comparative Example 4.

Device: (public) hard X-ray XAFS in Aichi Synchrotron Radiation Center, Science & Technology Foundation
Measurement range: 9897-11,297 eV (the peak position of the L absorption edge of tungsten)
Measurement method: the positive electrode was measured by a fluorescence method, and the tungsten compound was measured by a transmission method.

Here, in the transmission method for measuring the tungsten compound as a standard substance, transmitted X-rays when incident X-rays were emitted were detected, and in the fluorescence method for measuring the positive electrode, fluorescent X-rays generated when incident X-rays were emitted were detected, and even with the different measurement methods, the same spectrums could be expressed. When XAFS measurement data was normalized using analysis software Athena, it was possible to compare tungsten in the tungsten compound as a standard substance with tungsten in the positive electrode.

In order to obtain reproducibility of Formula (1), the standard sample was measured whenever the positive electrode sample was measured, and minute deviations were corrected.

### (Initial Resistance Evaluation)

For the evaluation batteries produced in the examples and comparative examples, an activation treatment was performed as follows, and the initial resistance was then measured. The evaluation battery was left in an environment of 25° C. For activation (initial charge), a constant current-constant voltage method was used, and each evaluation battery was subjected to constant current charging at a current value of ⅓C up to 4.2 V, and then subjected to constant voltage charging until the current value reached 1/50C, and fully charged. Then, each evaluation battery was subjected to constant current discharging at a current value of ⅓C up to 3.0 V. In this manner, the activation treatment was performed on each evaluation battery.

Each evaluation battery subjected to the activation treatment was adjusted to an open circuit voltage of 3.70 V. This battery was left in an environment of a temperature of −28° C. The battery was discharged at a current value of 20C for 8 seconds, and the voltage drop amount ΔV was obtained. Next, the voltage drop amount ΔV was divided by the discharge current value (20C) to calculate the battery resistance, which was used as the initial resistance. The ratio of the initial resistance of examples and comparative examples when the initial resistance of Comparative Example 1 was set to 1.00 was obtained. The results are shown in Table 1.

### (Evaluation of Resistance Increase Rate (Cycle Test))

Each evaluation battery for which the initial resistance was measured was left in an environment of 60° C., and constant current charging at 1° C. up to 4.2 V and constant current discharging at 10C up to 3.3 V were set as one cycle, and this charging and discharging was repeated over a total of 500 cycles. The battery resistance at the 500th cycle was measured in the same method as above. As an index for resistance increase, the resistance increase rate was obtained from the formula: (battery resistance at 500^{th} charging and discharging cycle-initial resistance)/initial resistance. Then, the ratio of the resistance increase rate of examples and comparative examples when the resistance increase rate of Comparative Example 1 was set to 1 was obtained. The results are shown in Table 1. Here, when the positive electrode layer was taken out of the evaluation battery after the cycle test and checked with a cross-sectional SEM, it was confirmed that the positive electrode active material with cracks was present in both examples and comparative examples.

TABLE 1

| | | Position | W/active | | Resistance |
|---|---|---|---|---|---|
| | (a − b)/ | of CNT | material | Initial | increase |
| | (c − d) | present | (mass %) | resistance | rate |
| Comparative | 1 | only surface | 0.5 | 1 | 1 |
| Example 1 | | of active | | | |
| | | material | | | |
| Comparative | 0.77 | only surface | 0.55 | 0.94 | 0.98 |
| Example 2 | | of active | | | |
| | | material | | | |
| Comparative | 0.98 | surface and | 0.53 | 0.95 | 0.87 |
| Example 3 | | inside of | | | |
| | | active | | | |
| | | material | | | |
| Comparative | 0.55 | only surface | 1 | 0.82 | 1.05 |
| Example 4 | | of active | | | |
| | | material | | | |
| Example 1 | 0.79 | surface and | 0.45 | 0.85 | 0.8 |
| | | inside of | | | |
| | | active | | | |
| | | material | | | |
| Example 2 | 0.54 | surface and | 0.47 | 0.78 | 0.86 |
| | | inside of | | | |
| | | active | | | |
| | | material | | | |
| Example 3 | 0.22 | surface and | 0.5 | 0.8 | 0.86 |
| | | inside of | | | |
| | | active | | | |
| | | material | | | |
| Example 4 | 0.56 | surface and | 0.95 | 0.75 | 0.89 |
| | | inside of | | | |
| | | active | | | |
| | | material | | | |

From Comparative Examples 2 and 3 and examples, when (a−b)/(c−d) was 0.79 or less and CNTs were also present inside the active material (voids of secondary particles) (that is, the positive electrode layer contained the first carbon nanotubes), the initial resistance was significantly reduced. This is thought to have been caused by the fact that a sufficient amount of electrons could be conducted to the inside of the active material while no cracks occurred in the active material. In addition, comparing Examples 1 to 4 and Comparative Example 3 with Comparative Examples 1, 2 and 4, the resistance increase rate after the cycle test was reduced. This is thought to have been caused by the fact that the electron conduction path was maintained even when cracks occurred in the active material due to the cycle test under strict conditions. Accordingly, it was found that, when the positive electrode layer in the present disclosure was used in a lithium ion battery, it was possible to reduce the resistance (initial resistance) of the lithium ion secondary battery and it was possible to exhibit favorable cycle characteristics.

What is claimed is:

1. A positive electrode layer used in a lithium ion secondary battery,
wherein the positive electrode layer contains a positive electrode active material and carbon nanotubes,
wherein the positive electrode active material contains tungsten and is secondary particles including a plurality of primary particles and voids formed between the plurality of primary particles,
wherein the positive electrode layer contains, as the carbon nanotubes, first carbon nanotubes of which at least some are included in the voids of the secondary particles, and
wherein spectrums at rising positions (10,195 eV to 10,206 eV) of peaks of L absorption edges of tungsten measured by X-ray absorption fine structure analysis (XAFS) satisfy:
$$( a - b ) / ( c - b ) \leq 0.79 \qquad Formula ( 1 )$$
[in Formula (1), a represents an energy (eV) when the slope of the spectrum is the largest in the range of 10,195 eV to 10,206 eV, and
when a spectral intensity at a (eV) is set as A,
b represents an energy (eV) at which the spectral intensity becomes A in a range of 10,195 eV to 10,206 eV of WO₂ (tungsten(IV) oxide), and
c represents an energy (eV) at which the spectral intensity becomes A in a range of 10,195 eV to 10,206 eV of WO₃ (tungsten(VI) oxide)].

2. The positive electrode layer according to claim 1, wherein the positive electrode layer contains, as the carbon nanotubes, second carbon nanotubes that are not included in the voids of the secondary particles.

3. The positive electrode layer according to claim 1, wherein Formula (1) satisfies 0.22≤(a−b)/(c−b)≤0.79.

4. The positive electrode layer according to claim 1, wherein the positive electrode active material contains a lithium metal composite oxide.
